(19) United States
(12) Patent Application Publication
(10) Pub. No.: US 2024/0211209 A1
(43) Pub. Date: Jun. 27, 2024

(54) FLOATING POINT FUSED MULTIPLY ACCUMULATE

(71) Applicant: Arm Limited, Cambridge (GB)

(72) Inventor: Olof Henrik Uhrenholt, Lomma (SE)

(21) Appl. No.: 18/145,757

(22) Filed: Dec. 22, 2022

(51) Int. Cl. G06F 7/487

(52) U.S. Cl. CPC G06F 7/4876

(57) ABSTRACT

The present disclosure relates to a data processing apparatus comprising: instruction decode circuitry to decode instructions; processing circuitry to execute said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and an operand storage module operable to store said first floating-point operand, said second floating-point operand, and said third floating-point operand, wherein, responsive to said FMA instruction, said FMA circuitry is configured to: perform denormal detection on said first floating-point operand, said second floating-point operand and said third floating-point operand to determine if one or more of said first floating-point operand, said second floating-point operand or said third floating-point operand meets a first denormal condition; upon determining that at least one of said first floating-point operand, said second floating-point operand or said third floating-point operand meets said first denormal condition, execute a denormal handling instruction to: generate a shifted first floating-point operand (ta) based on said first floating-point operand, a shifted second floating-point operand (tb) based on said second floating-point operand, and a shifted third floating-point operand (tc) based on said third floating-point operand; write said shifted first floating-point operand, said shifted second floating-point operand and said shifted third floating-point operand to auxiliary storage of said operand storage module, said auxiliary storage being temporary storage configured within said operand storage module and assigned to said denormal handling instruction; and execute said FMA instruction using said shifted first floating-point operand, said shifted second floating-point operand and said shifted third floating-point operand to generate a shifted FMA output.

### FIELD OF THE INVENTION

The present technology relates to data processing systems and apparatuses, in particular for the processing of floating-point numbers.

### BACKGROUND

A multiply-accumulate operation involves multiplying together two operands (e.g. multiplicands) and then adding a third operand (e.g. an addend). Such an operation can be represented as:

(a×b)+c
where a and b are the multiplicands and c is the addend.

A multiply-accumulate operation involving three floating-point (FP) operands can be performed by a fused-multiply-accumulate or fused-multiply-add (FMA) unit, which computes the product of the multiplicands and add the addend to the product in one step before a single rounding to a predetermined significant bits. Such FMA units may be implemented in data processing apparatuses, such as a central processing unit (CPU) or a graphics processing unit (GPU) (e.g. within a shader core), to execute FMA instructions.

### BRIEF DESCRIPTION OF THE DRAWINGS

Embodiments will now be described, with reference to the accompanying drawings, in which:

FIG. 1A shows schematically an exemplary system comprising a CPU and a GPU;

FIG. 1B shows schematically an exemplary GPU comprising an FMA unit;

FIG. 2 shows schematically an exemplary fused-multiply-accumulate FMA pipeline;

FIG. 3 shows a flow diagram of an exemplary method of handling a fused-multiply-accumulate FMA instruction; and

FIG. 4 shows an example of denormal detection.

### DETAILED DESCRIPTION

In view of the foregoing, an aspect of the present technology provides a data processing apparatus comprising: instruction decode circuitry to decode instructions; processing circuitry to execute said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and an operand storage module operable to store said first floating-point operand, said second floating-point operand, and said third floating-point operand, wherein, responsive to said FMA instruction, said FMA circuitry is configured to: perform denormal detection on said first floating-point operand, said second floating-point operand and said third floating-point operand to determine if one or more of said first floating-point operand, said second floating-point operand or said third floating-point operand meets a first denormal condition; upon determining that at least one of said first floating-point operand, said second floating-point operand or said third floating-point operand meets said first denormal condition, execute a denormal handling instruction to: generate a shifted first floating-point operand (ta) based on said first floating-point operand, a shifted second floating-point operand (tb) based on said second floating-point operand, and a shifted third floating-point operand (tc) based on said third floating-point operand; write said shifted first floating-point operand, said shifted second floating-point operand and said shifted third floating-point operand to auxiliary storage of said operand storage module, said auxiliary storage being temporary storage configured within said operand storage module and assigned to said denormal handling instruction; and execute said FMA instruction using said shifted first floating-point operand, said shifted second floating-point operand and said shifted third floating-point operand to generate a shifted FMA output.

According to embodiments of the present technology, at the start of executing an FMA instruction specifying a first floating-point (FP) operand, a, a second FP operand, b, and a third FP operand, c, denormal detection is performed on the operands to determine if a first denormal condition is met before commencing FMA processing. If one or more of the first, second and third FP operands meet the first denormal condition, meaning that the one or more of the first, second and third FP operands are denormal, a denormal handling instruction is triggered, and the first, second and third FP operands are passed to a denormal handling subroutine. The denormal handling subroutine generates shifted FP operands, ta, tb and tc, from the first, second and third FP operands and writes the shifted first, second and third FP operands to auxiliary storage within the operand storage module (e.g. operand buffer). The auxiliary storage is storage (e.g. registers) specifically dedicated for use by the denormal handling subroutine and independent of the rest of the operand storage module, such that writing to the auxiliary storage would not overwrite data already stored on the operand storage module (e.g. register file storing the first, second and third FP operands). Using the shifted first, second and third FP operands stored on the auxiliary storage, the denormal handling subroutine executes the FMA instruction to generate a shifted FMA output, e.g. (tax tb)+tc. In doing so, it is possible to remove denormal handling from the FMA processing pipeline, but preserve denormal handling functionality through denormal detection to trigger a micro-coded independent control path that is the denormal handling subroutine if one (or more) of the first, second and third FP operands is determined to be denormal. The denormal handling subroutine/control path uses dedicated temporary storage on the operand storage module to temporarily store data required by the control path to enable the denormal handling instruction to be executed back-to-back. Moreover, since data on the auxiliary storage is separate from the rest of the operand storage module, data stored on the operand storage module is preserved without being overwritten while the denormal handling control path is executed. By removing denormal handling from the FMA processing pipeline, it is possible to reduce demands on processing resources and improve processing speed.

In some embodiments, said FMA circuitry may be configured to, upon determining that none of said first floating-point operand, said second floating-point operand, and said third floating-point operand meets said first denormal condition, execute said FMA instruction using said first floating-point operand, said second floating-point operand, and said third floating-point operand to generate an FMA output.

When the denormal detection determines that none of the first, second or third FP operands is denormal, there may be instances when the expected FMA result generated using these operands is denormal. Thus, in some embodiments, said FMA circuitry may be further configured to: perform said denormal detection on said first floating-point operand, said second floating-point operand and said third floating-point operand to determine if an expected FMA output based on said first floating-point operand, said second floating-point operand and said third floating-point operand meets a second denormal condition.

In some embodiments, said FMA circuitry may be configured to: upon determining that said expected FMA output meets said second denormal condition, execute said denormal handling instruction; or upon determining that said expected FMA output does not meet said second denormal condition, omit said denormal handling instruction and execute said FMA instruction using said first floating-point operand, said second floating-point operand, and said third floating-point operand to generate an FMA output. By performing the denormal detection on the expected FMA output, it is possible to ensure a denormal is handled and not missed. On the other hand, when it is determined that the expected FMA output is not denormal, the denormal handling instruction (denormal handling micro-coded control path) can be omitted entirely to conserve processing resources. The impact on the conservation of processing resources through omission of denormal handling can be significant, especially in cases where FMA units are used frequently while denormal is uncommon, for example (but not limited to) in a shader core of a graphics processing unit (GPU).

In some embodiments, said first floating-point operand may comprise a first biased exponent, said second floating-point operand may comprise a second biased exponent, and said third floating-point operand may comprise a third biased exponent, and said first denormal condition may be met when said first biased exponent, said second biased exponent or said third biased exponent is 0.

In some embodiments, said first floating-point operand may comprise a first exponent (ea), said second floating-point operand may comprise a second exponent (eb), and said third floating-point operand may comprise a third exponent (ec), and wherein whether said expected FMA output meets said second denormal condition may be determined by: a first inequality based on the sum of said first exponent and said second exponent, ea+eb, when a product of said first floating-point operand and said second floating-point operand, a*b, dominates over said third floating-point operand, c; or a second inequality based on said third exponent, ec, when said third floating-point operand, c, dominates over said product of said first floating-point operand and said second floating-point operand, a*b; or a third inequality based on of said first exponent and said second exponent, ea+eb, and said third exponent, ec, when said product of said first floating-point operand and said second floating-point operand, a*b, and said third floating-point operand, c, are similar in magnitude.

In some embodiments, said FMA circuitry may be configured to execute said denormal handling instruction further to: generate said shifted first floating-point operand (ta) based on said first floating-point operand by adding a first integer x to a first exponent (ea); generate said shifted second floating-point operand (tb) based on said second floating-point operand by adding a second integer y to a second exponent (eb); and generate said shifted third floating-point operand (tc) based on said third floating-point operand by adding a third integer z to a third exponent (ec), wherein each of said first exponent, said second exponent or said third exponent is a respective exponent of said first floating-point operand, said second floating-point operand and said third floating-point operand, and said third integer is a sum of said first integer and said second integer, z=x+y, wherein, optionally, an operation to generate said shifted first, second or third floating-point operand is an “Idexp” operation.

In some embodiments, said FMA circuitry may be configured to execute said denormal handling instruction further to: write said shifted FMA output to said auxiliary storage of said operand storage module; and generate an FMA output based on said shifted FMA output. Thus, in these embodiments, denormal handling may begin with shifting the exponent of the first FP operand by adding an integer x to the exponent of the first FP operand to obtain the shifted first FP operand, shifting the exponent of the second FP operand by adding an integer y to the exponent of the second FP operand to obtain the shifted second FP operand, and shifting the exponent of the third FP operand by adding an integer z=x+y to the exponent of the third FP operand to obtain the shifted third FP operand. Then, FMA is performed using the shifted first, second and third FP operands. Through the first and/or second denormal detection, the denormal handling instruction is only triggered when at least one of the first or second denormal conditions is met; thus the shifting of the exponents of the first, second and third FP operands would not cause a spurious overflow in the shifting operation or the FMA operation.

Once FMA is performed on the shifted operands, the exponent of the output may be back-shifted by the same amount to obtain the correct FMA output. Thus, in some embodiments, said FMA circuitry may generate said FMA output based on said shifted FMA output by subtracting said third integer from an exponent of said shifted FMA output.

The magnitude of the integers x and y need not be the same and can be different if desired, as long as the third exponent is shifted by an amount x+y. An upper limit to the magnitude of x and y may be desired to ensure that the shifted exponents do not overflow. Where such overflow occurs depends on the precision of a floating-point operand. Thus, in some embodiments, said first integer (x) may be set within a first predetermined range of numbers determined based on a precision specified for said first floating-point operand, and said second integer (y) may be set within a second predetermined range of numbers determined based on a precision specified for said second floating-point operand.

In some embodiments, said first integer and said second integer may be set to be a same number.

In some embodiments, said first floating-point operand and said second floating-point operand may be single-precision floating-point numbers, and said first integer and said second integer may be set to be 24.

In some embodiments, said FMA circuitry may be configured to execute said denormal handling instruction further to: upon generating said shifted FMA output, invalidate said shifted first floating-point operand, said shifted second floating-point operand and said shifted third floating-point operand on said auxiliary storage of said operand storage module. Once the denormal handling instruction/subroutine is completed, the first, second and third shifted FP operands are no longer required. Thus, by invalidating these shifted operands on the auxiliary storage upon completion of denormal handling, the auxiliary storage can be overwritten when denormal handling is required again.

Another aspect of the present technology provides a computer-implemented method comprising: instruction decode circuitry decoding instructions; processing circuitry executing said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and an operand storage module storing said first floating-point operand, said second floating-point operand, and said third floating-point operand, the method further comprising, responsive to said FMA instruction, said FMA circuitry: performing denormal detection on said first floating-point operand, said second floating-point operand and said third floating-point operand to determine if one or more of said first floating-point operand, said second floating-point operand or said third floating-point operand meets a first denormal condition; upon determining that at least one of said first floating-point operand, said second floating-point operand or said third floating-point operand meets said first denormal condition, executing a denormal handling instruction: generating a shifted first floating-point operand (ta) based on said first floating-point operand, a shifted second floating-point operand (tb) based on said second floating-point operand, and a shifted third floating-point operand (tc) based on said third floating-point operand; writing said shifted first floating-point operand, said shifted second floating-point operand and said shifted third floating-point operand to auxiliary storage of said operand storage module, said auxiliary storage being temporary storage configured within said operand storage module and assigned to said denormal handling instruction; and executing said FMA instruction using said shifted first floating-point operand, said shifted second floating-point operand and said shifted third floating-point operand to generate a shifted FMA output.

A further aspect of the present technology provides a non-transitory computer-readable medium to store computer-readable code for fabrication of a data processing apparatus comprising: instruction decode circuitry to decode instructions; processing circuitry to execute said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and an operand storage module operable to store said first floating-point operand, said second floating-point operand, and said third floating-point operand, wherein, responsive to said FMA instruction, said FMA circuitry is configured to: perform denormal detection on said first floating-point operand, said second floating-point operand and said third floating-point operand to determine if one or more of said first floating-point operand, said second floating-point operand or said third floating-point operand meets a first denormal condition; upon determining that at least one of said first floating-point operand, said second floating-point operand or said third floating-point operand meets said first denormal condition, execute a denormal handling instruction to: generate a shifted first floating-point operand (ta) based on said first floating-point operand, a shifted second floating-point operand (tb) based on said second floating-point operand, and a shifted third floating-point operand (tc) based on said third floating-point operand; write said shifted first floating-point operand, said shifted second floating-point operand and said shifted third floating-point operand to auxiliary storage of said operand storage module, said auxiliary storage being temporary storage configured within said operand storage module and assigned to said denormal handling instruction; and execute said FMA instruction using said shifted first floating-point operand, said shifted second floating-point operand and said shifted third floating-point operand to generate a shifted FMA output.

In some embodiments, the data processing apparatus comprises a central processing unit (CPU) or a graphics processing unit (GPU), wherein the central processing unit or the graphics processing unit comprises the processing circuitry.

Both CPUs and GPUs are processing elements comprising processing circuitry to execute instructions. A GPU may be a specialised processing element, specialising in performing processes related to generation of images. The present technology can be implemented within either a CPU or a GPU (or any other type of processing element). However, the present technology may be particularly advantageous when implemented on FMA units in a GPU, e.g. in shader cores, to perform multiply-accumulate operations, since denormal handling is often not required. Hence, aspects of the present technology can be particularly useful when implemented in a GPU by offering improved efficiency.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

Floating-point (FP) is a way of approximating real numbers, and there exist a number of different formats for FP numbers that represent FP numbers by different number of bits (therefore different precision). These include (but not limited to) double precision, or DP, which uses 64 bits, single precision, or SP, which uses 32 bits, and half precision, or HP, which uses 16 bits.

FP numbers typically comprise a sign bit, a number of biased exponent bits, and a number of fraction (e.g. significand or mantissa) bits. For example, DP, SP and HP formats comprise the following bits,

| | | | | | | exponent |
|---|---|---|---|---|---|---|
| format | sign | exponent | | fraction | | bias |
| DP [63:0] | 63 | 62:52 | (11 bits) | 51:0 | (52 bits) | 1023 |
| SP [31:0] | 31 | 30:23 | (8 bits) | 22:0 | (23 bits) | 127 |
| HP [15:0] | 15 | 14:10 | (5 bits) | 9:0 | (10 bits) | 15 |

The sign is 1 for negative numbers and 0 for positive numbers. Every number, including zero, has a sign.

The exponent is biased, such that the actual exponent of the FP number differs from what is represented by the exponent bits. For example, biased SP exponents are 8-bits long and range from 0 to 255. Exponents 0 and 255 (in SP) typically represent special cases, while all other exponents have a bias of 127, such that the actual exponent is 127 less than the biased exponent. The smallest biased exponent is, therefore, 1 and corresponds to an actual exponent of −126, while the largest biased exponent is 254 and corresponds to an actual exponent of 127. Exponent zero, in any of the formats, is typically reserved for denormal/subnormal numbers and zeros.

A normal number represents the value:

$$( - {1}^{s} ) \times 1 . f \times {2}^{e}$$

where e is the actual exponent computed from the biased exponent. The term 1.f is the significand (or mantissa/fraction), and the leading 1 is not typically stored as part of the FP number; rather it is inferred from the exponent. Thus, all exponents except zero and the maximum exponent indicate a significand of the form 1.f where “f” is the part of the mantissa that is stored, while the leading 1 is implicit. The exponent zero indicates a significand of the form 0.f, and an actual exponent that is equal to 1-bias for the given format. Such a number is called denormal or subnormal. A large part of the complexity of FP implementation is due to denormals, which must be handled different from normal numbers.

In general, FP arithmetic is similar to arithmetic performed on decimal numbers written in scientific notation. For example, multiplying together two FP operands involves multiplying their mantissas and adding their exponents, e.g.:

$$a = ( - {1}^{s i g n a} ) \times m a n t i s s {a}_{a} \times {2}^{e x p a}$$

$$b = ( - {1}^{s i g n b} ) \times m a n t i s s {a}_{b} \times {2}^{e x p b}$$

$$a \times b = ( ( - {1}^{s i g n a} ) \times m a n t i s s {a}_{a} \times {2}^{e x p a} ) \times ( ( - {1}^{s i g n b} ) \times m a n t i s s {a}_{b} \times {2}^{e x p b} )$$

$$a \times b = ( - {1}^{( s i g n a + s i g n b )} ) \times ( m a n t i s s {a}_{a} \times m a n t i s s {a}_{b} ) \times {2}^{( e x p a + e x p b )}$$

where the terms (−1^{signa}) and (−1^{signb}) represent the sign (positive or negative) or each of the FP operands. For example, the sign bit (signa/signb) can be 0 or 1, so that if signa=1, the sign of the operand a is negative (since−1¹=−1), whereas if signa=0, the sign of a is positive (since −1⁰=1).

Addition of two FP operands, on the other hand, involves manipulating one of the operands so that both operands have the same exponent, and then adding the mantissas. For example, consider adding the following FP operands:

$$a = 1.11011 \times {2}^{2}$$

$$b = 1. 00101 \times {2}^{3}$$

When the exponents are different, one of the exponents would be selected and the other operand would be manipulated (or shifted) so that both have the same exponent. Typically, the larger exponent is selected. In the example above, if the larger exponent 3 (the exponent of b) is selected, the mantissa of the FP operand a would need to be shifted by one place to the right:

$$a = 1.11011 \times {2}^{2} = 0.111011 \times {2}^{3}$$

The mantissas can then be added:

$$a + b = ( 0.111011 + 1.00101 ) \times {2}^{3} = 1.111011 \times {2}^{3}$$

Multiply-accumulate operations of the form (a×b)+c make use of the above principles.

The present technology relates to a fused-multiply-add (FMA) unit (or FMA circuitry) which performs a multiply-add operation using three floating point (FP) operands and generates a result of the multiply-add operation. Each operand may, for example, comprise a sign, a mantissa (or fraction or significand) and an exponent, as explained above. For example, an FP operand may take the form:

$$\pm mantissa \times {2}^{exponent}$$

An FMA unit performs an FMA operation by computing the product of the multiplicands (e.g. the first and second FP operands) and adding the addend (e.g. the third FP operand) to the product then rounding the result.

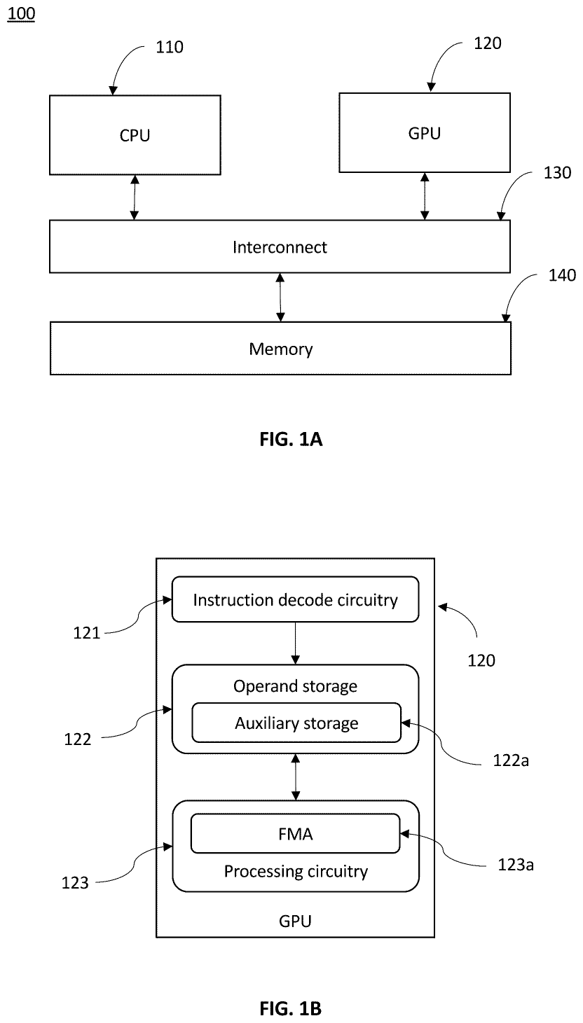

An implementation example is shown in FIG. 1A, which schematically shows an exemplary data processing system 100 comprising a CPU 110 and a GPU 120 in communication with a shared memory 140 via an interconnect 130. Herein, the CPU 110 and GPU 120 may also be referred to as processing elements, processors, or cores, and each comprises processing circuitry to execute instructions. The instructions may be stored in memory 140, and the processing elements CPU 110 and GPU 120 may be configured to perform operations on data stored in memory 140 when executing instructions.

According to present embodiments, the data processing system 100 comprises, in the processing circuitry of either the CPU 110 or the GPU 120, or both, an FMA unit (herein also referred to as FMA circuitry) to execute FMA instructions. An FMA instruction identifies three FP operands (e.g. a, b and c), and the FMA unit is responsive to the FMA instruction to determine a result corresponding to the expression (a*b)+c. An example is shown in FIG. 1B, which schematically shows processing circuitry 123 of the GPU 120 comprising an FMA unit 123a. In the present embodiment, instructions are decoded by instruction decode circuitry 121, and the decoded instructions are executed by the processing circuitry 123. When a decoded instruction is an FMA instruction specifying a first FP operand a, a second FP operand b, and a third FP operand c, the first, second and third operands are written to an operand storage 122, e.g. in a register file. The FMA unit 123 of the processing circuitry 123 then perform an FMA operation using the first, second and third FP operands on the operand storage 122. In the present embodiment, the operand storage 122 comprises an auxiliary storage 122a which is configured to be operated independently of the rest of the operand storage 122, such that writing data to the auxiliary storage 122a does not overwrite any data in other parts of the operand storage 122. The auxiliary storage 122a is configured as dedicated temporary storage for denormal handling, which will be explained in more detail below.

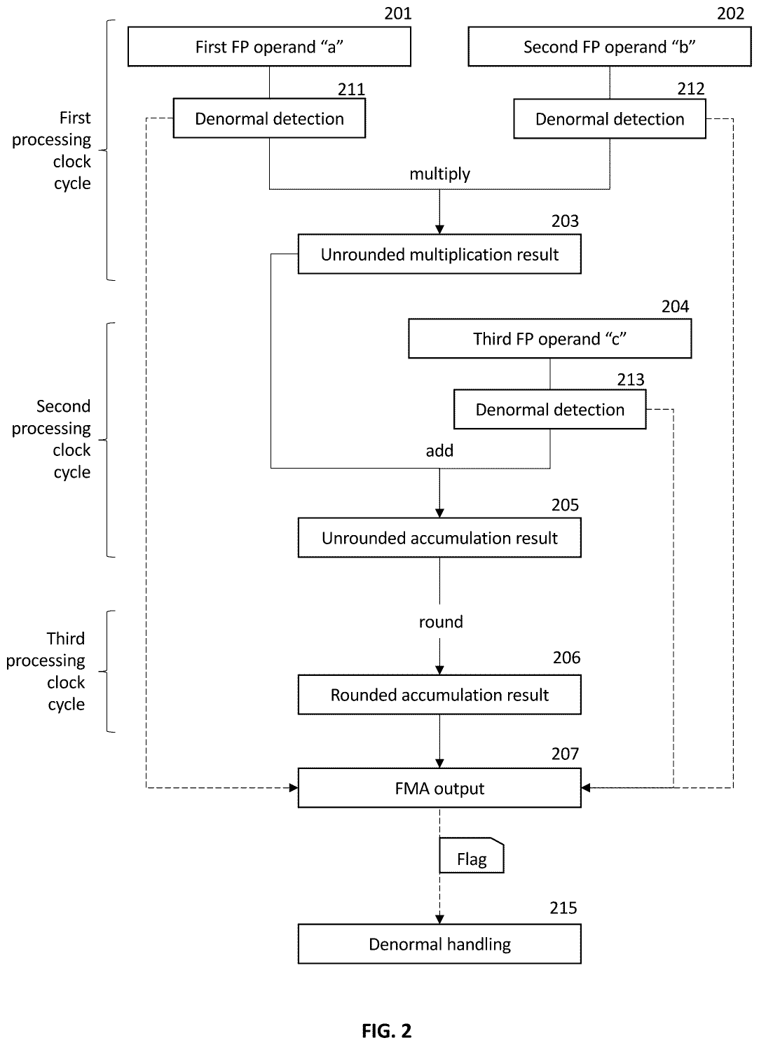

An FMA unit, such as the FMA unit 123a, generally processes FMA instructions in a pipeline. Such a pipeline typically comprises one or more stages (e.g. four stages), requiring one or more processing clock cycles to complete the execution of an FMA instruction. FIG. 2 schematically illustrates the processing of the various input operands and their relationship to intermediate values during a fused-multiply-add operation in an FMA pipeline. A first FP input operand 201 and a second FP input operand 202 are multiplied together during a first processing clock cycle to generate an unrounded multiplication result 203. The unrounded multiplication result 203 is then added to a third input operand 204 during a second processing cycle to generate an unrounded accumulation result 205. During a third processing clock cycle, the unrounded accumulation result 205 is input to a rounding operation to generate a rounded accumulation result 206, which becomes the output 207 of the FMA operation. It should be noted that the stages shown in FIG. 2 are examples only for the purpose of illustration; other number of stages and/or other ways of arranging the various stages are of course possible and would be clear to a skilled reader.

FMA units can consume a significant amount of processing resources. For example, a GPU shader core may comprise a large number of FMA units (e.g. 128), and together the FMA units can take up ˜12% of the shader core area. In particular (though not limited to), as FMA units are typically instantiated frequently in a GPU shader core, there is, therefore, scope for improving the efficiency of FMA units.

In conventional approaches, denormal handling functionality is built into an FMA pipeline across the one or more stages to handle any denormal numbers. For example, FP operands are normalized before the multiplication stage commences. This requires one or more input shifters for the mantissa for each of the input operands. Similarly, an output mantissa shifter is provided to the final stage of the FMA pipeline to normalize an output if the output of an FMA instruction is denormal. However, denormals are generally rare and for many applications that require FMA operations, denormal handling is either not required or is made optional.

As such, approaches of the present technology provide apparatuses comprising FMA circuitry, and methods of operating FMA circuitry, that implement denormal handling functionality with improved efficiency. In particular, present approaches seek to remove denormal logic from an FMA pipeline, while preserving denormal handling functionality through a denormal trapping functionality and a separate micro-coded denormal handling control path. Through removing input and output mantissa shifters and associated denormal tracking in an FMA pipeline, it is possible to improve on processing time and resource and energy consumption. It is proposed that such improvements may enable a reduction in the length of an FMA pipeline and/or a reduction in a silicon area, for example a reduction of a four-staged FMA pipeline to a three-staged pipeline.

According to an embodiment, denormal handling functionality is preserved in the FMA unit by performing a denormal detection on the input operands and the output of the FMA instruction. If any one of a, b, c or the output (a*b+c) is denormal, the FMA pipeline outputs an indication (e.g. a flag) to indicate that denormal handling is required, which triggers execution of the denormal handling control path (denormal handling instruction).

Returning to FIG. 2, denormal detection 211, 212, 213 is performed on the first FP operand a, the second FP operand b and the third FP operand c. The denormal detection 211, 212, 213 determines a first denormal condition (or a first set of denormal conditions) is met. In the present embodiment, the first denormal condition is met when at least one (or more) of the first, second or third FP operands (a, b or c) is denormal. For example, denormal detection 211, 212, 213 may determine that an input FP operand is denormal when the biased exponent of the input FP operand is 0.

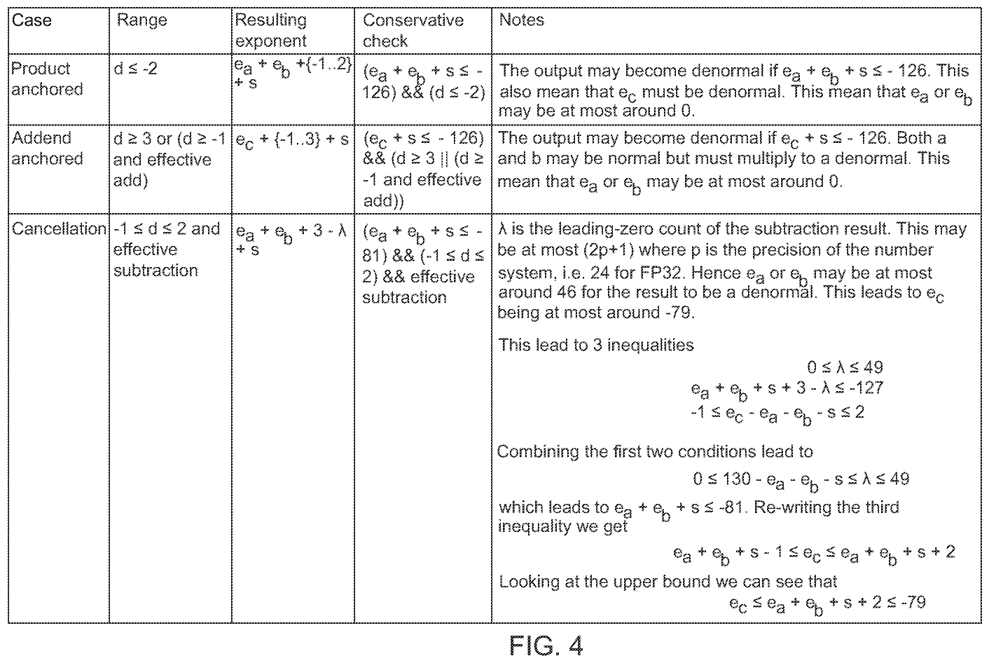

There may be instances in which none of the input FP operands a, b or c are denormal, but an FMA operation performed of these input FP operands may return a denormal output. Thus, in the present embodiment, denormal detection 211, 212, 213 further determines if an expected output of an FMA operation on the input FP operands a, b and c meets a second denormal condition (may be denormal). For example, detection 211, 212, 213 may use the exponents ea, eb and ec of the respective FP operands a, b and c to determine the exponent of the expected output, and the second denormal condition on the input FP operands is met when the exponent of the expected output corresponds to a denormal value. A denormal value may be set e.g. based on the precision of the input FP operands. Various known techniques may be used for the determination of denormal conditions (second denormal condition) on an expected FMA output based on input FP operands. An example of such techniques is shown in FIG. 4, wherein three mutually exclusive cases are considered for different range of d, where d=e_{c}−(eₐ+e_{b}). In particular, the determination of denormal conditions on an expected FMA output may for example be performed by considering: (i) a first inequality based on the sum of said first exponent and said second exponent, ea+eb, when a product of said first floating-point operand and said second floating-point operand, a*b, dominates over said third floating-point operand, c (“product anchored”); (ii) a second inequality based on said third exponent, ec, when said third floating-point operand, c, dominates over said product of said first floating-point operand and said second floating-point operand, a*b (“addend anchored”); or (iii) a third inequality based on of said first exponent and said second exponent, ea+eb, and said third exponent, ec, when said product of said first floating-point operand and said second floating-point operand, a*b, and said third floating-point operand, c, are similar in magnitude.

If denormal detection 211, 212, 213 determines that none of the input FP operands are denormal (first denormal condition is not met), and the expected FMA output of the input FP operands is not denormal (second denormal condition is not met), then execution of the FMA instruction proceeds through the FMA pipeline to obtain the result of the multiply-accumulate operation (a*b+c).

If, on the other hand, denormal detection 211, 212, 213 determines that at least one of the input FP operands is denormal (first denormal condition is met), or the expected FMA output of the input FP operands is denormal (second denormal condition is met), then the FMA pipeline outputs an indication (e.g. a flag) that denormal is detected to trigger execution of a denormal handling instruction 215. Thus, the present embodiment provides a dedicated control path (denormal detection 211, 212, 213) to “trap” denormal input operands and/or denormal output, but allows input operands to proceed through the FMA pipeline without unnecessary denormal handling when no denormal is detected.

In an embodiment, execution of the denormal handling instruction 215 comprises execution of a micro-coded sequence, an example of which is defined below:

fp32 fma_trap(fp32 a, fp32 b, fp32 c, RoundMode rm)
{
fp32 ta = ldexp(a, 24);
fp32 tb = ldexp(b, 24);
fp32 tc = ldexp(c, 48);
ta = fma(ta, tb, tc);
return ldexp(ta, −48, rm);
}

In the present embodiment, the denormal handling instruction is arranged to be executed as if the sequence was part of the same cache line as the FMA operation. According to the present embodiment, the denormal handling instruction is a streamlined branch-free sequence comprising a small number of instructions (five in the present example, but other numbers of instructions are of course possible) that are executed back-to-back in turn without returning to a scheduler or an instruction cache. The denormal handling sequence can therefore be executed efficiently, independently of the FMA pipeline, and may be called only as and when it is needed.

In the present embodiment, the denormal handling sequence takes the input operands a, b and c specified in the FMA instruction and performs operations to shift the respective exponent of each of the input operands a, b and c. The operations shift or increase the exponent ea of the input operand a by a first integer x to obtain a shifted first FP operand ta, shift or increase the exponent eb of the input operand b by a second integer y to obtain a shifted second FP operand tb, and shift or increase the exponent ec of the input operand c by a third integer z to obtain a shifted (or normalized) third FP operand tc. For example, if the input operands are single precision FP numbers (FP32), then x may be 24, y may be 24, and z=x+y=48. Then FMA operation is performed on the shifted inputs ta, tb and tc to obtain a shifted FMA output (ta*tb+tc). The exponent of the shifted FMA output is back-shifted by −(x+y)=−48 to obtain the correct FMA output.

It should be noted that the number range of the first and second integers x and y depends on the type (size) of FP number, while the third integer z equals the sum of x and y. In the present embodiment, the input FP operands a, b and c are FP32 values and so each of x and y has a minimum value of 24 to ensure that the shift performed on the exponents of a and b gives a non-denormal value. The first and second integers x and y need not be the same number as long as the exponent of c is shifted by the sum x+y. An upper limit may be imposed on the integers x and y, if desired, to ensure that the shifted values ta, tb and tc do not overflow. It would be clear to a skilled reader that for input operands of other floating-point formats, the lower and upper limits of the integers x and y would be different. According to present embodiments, since the denormal handling sequence is only triggered if and when the input FP operands meet the first denormal condition or the second denormal condition, the operations Idexp to shift the exponents of the input FP operands and/or fma to perform FMA operation on the shifted input FP operands would not result in a spurious overflow.

In order to enable the denormal handling sequence to be executed back-to-back, dedicated temporary registers are provided on an operand buffer used by the FMA unit/circuitry (e.g. shown as auxiliary storage 122a of the operand storage 122 in FIG. 1B) to store the shifted operands ta, tb and tc and the shifted FMA output (ta*tb+c). The operand buffer (e.g. operand storage 122) is a quick-access storage (e.g. cache) for register files that stores e.g. FMA input operands (the values for the input FP operands a, b and c). In the present embodiment, three temporary registers are provided, to respectively store the shifted operands ta, tb and tc. Then, as shown in the example denormal sequence above, once the shifted FMA output (ta*tb+tc) is obtained, the output may be written to one or the three temporary registers as the value (e.g. ta, tb or tc) stored thereon is no longer required. Dedicating temporary registers as auxiliary storage on the operand storage module for the normalized (shifted) FP operands ta, tb and tc to be written to enables special conditions to be set for the auxiliary storage, in order to prevent the content of the temporary registers being written to the main register file on the operand storage module that could potentially overwrite the FMA input operands stored thereon. In doing so, it is possible to preserve the values that are stored on the operand buffer, e.g. input FP operands specified by an FMA instruction, while allowing additional values to be stored temporarily in order to enable the denormal handling sequence to be executed. Then, upon completion of the denormal handling sequence, the values (e.g. ta, tb and tc) stored on the temporary registers on the auxiliary storage may be invalidated such that the temporary registers may be overwritten with new values for subsequent denormal handling.

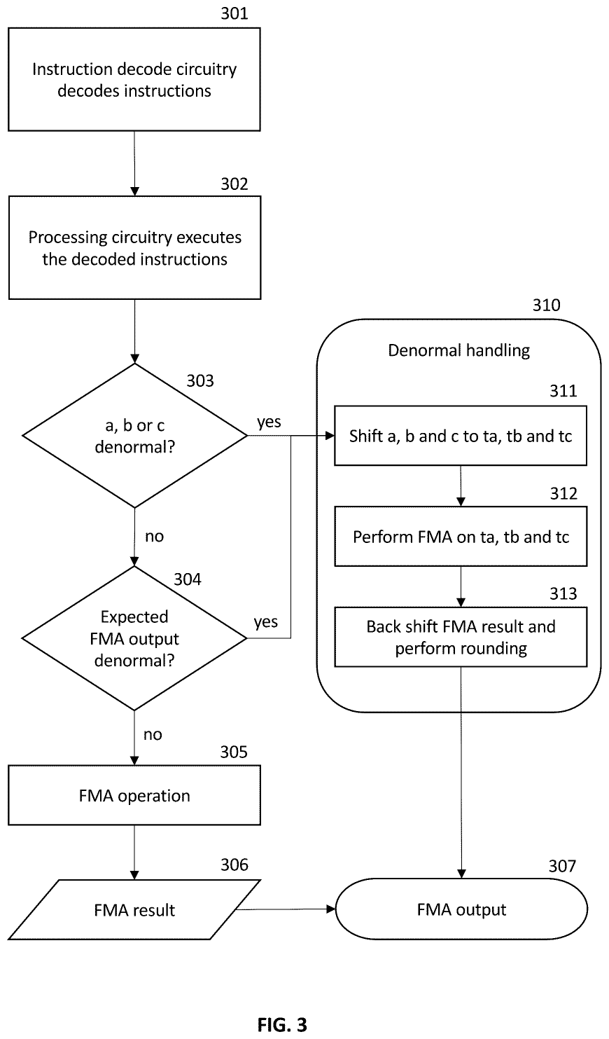

FIG. 3 shows a flow diagram illustrating an exemplary method of performing an FMA operation by a data processing apparatus according to an embodiment, such as the data processing apparatus GPU 120 in FIG. 1B. The operation begins at 301 when instruction decode circuitry of the data processing apparatus, e.g. instruction decode circuitry 121, decodes an FMA instruction specifying a first FP operand a, a second FP operand b and a third FP operand c. Processing circuitry, e.g. processing circuitry 123, comprising FMA circuitry, e.g. FMA circuitry 123a, then execute the decoded FMA instruction at 302. At 303, denormal detection is performed on the first, second and third FP operands to determine if a first denormal condition is met, i.e. if any of the first, second or third FP operand is denormal. At 304, if the first denormal condition is not met, denormal detection is further performed on an expected FMA output of the first, second and third FP operands to determine if a second denormal condition is met, i.e. if the expected FMA output is denormal. As explained above, the second denormal condition may be set based on a numerical relationship between the exponents of the first, second and third FP operands, which gives an indication of the exponent of the expected FMA output, with respect to the floating-point number format (or precision) of the first, second and third FP operands. If the second denormal condition is also not met, it is determined that the input FP operands and the resulting FMA output are not denormal, and execution of the FMA instruction proceeds to 305 at which the first, second and third FP operands are input to an FMA operation to obtain an FMA result (a*b+c) at 306. The FMA result is then output at 307.

If at 303, it is determined that the first denormal condition is met, or at 304, it is determined that the second denormal condition is met, execution of the FMA instruction activates a denormal handling control path 310 to execute a denormal handling instruction. In an embodiment, the denormal handling instruction may comprise an instruction sequence such as the example sequence shown above. For example, the denormal handling instruction sequence 310 may comprise, at 311, shifting the exponents of the first, second and third FP operands respectively by a first (x), second (y) and third (z) integers (e.g. x=24, y=24, z=48) to generate shifted or normalized FP operands ta, tb and tc, then, at 312, perform an FMA operation on the normalized first, second and third FP operands. The resulting shifted FMA output (ta*tb+tc) is then back-shifted at 313 by the third integer z and rounding is performed to generate the (correct) final output for the FMA instruction at 307.

Thus, according to embodiments disclosed herein, denormal support may be removed from an FMA pipeline, while denormal handling functionality is preserved in the FMA unit through denormal detection or trapping performed on the input operands. A separate denormal handling control path, facilitated by dedicated auxiliary storage on an operand storage module used by the FMA unit, is only activated when denormal is detected, such that when no denormal is detected, the denormal handling control path can be omitted altogether. Through embodiments of the present technology, it is possible to reduce FMA data path area, improve efficiency and reduce processing time.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A data processing apparatus comprising:
instruction decode circuitry to decode instructions;
processing circuitry to execute said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and
an operand storage module operable to store said first floating-point operand, said second floating-point operand, and said third floating-point operand,
wherein, responsive to said FMA instruction, said FMA circuitry is configured to:
perform denormal detection on said first floating-point operand, said second floating-point operand and said third floating-point operand to determine if one or more of said first floating-point operand, said second floating-point operand or said third floating-point operand meets a first denormal condition;
upon determining that at least one of said first floating-point operand, said second floating-point operand or said third floating-point operand meets said first denormal condition, execute a denormal handling instruction to:
generate a shifted first floating-point operand (ta) based on said first floating-point operand, a shifted second floating-point operand (tb) based on said second floating-point operand, and a shifted third floating-point operand (tc) based on said third floating-point operand;
write said shifted first floating-point operand, said shifted second floating-point operand and said shifted third floating-point operand to auxiliary storage of said operand storage module, said auxiliary storage being temporary storage configured within said operand storage module and assigned to said denormal handling instruction; and
execute said FMA instruction using said shifted first floating-point operand, said shifted second floating-point operand and said shifted third floating-point operand to generate a shifted FMA output.

2. The data processing apparatus of claim 1, wherein said FMA circuitry is configured to, upon determining that none of said first floating-point operand, said second floating-point operand, and said third floating-point operand meets said first denormal condition, execute said FMA instruction using said first floating-point operand, said second floating-point operand, and said third floating-point operand to generate an FMA output.

3. The data processing apparatus of claim 1, wherein said FMA circuitry is further configured to:
perform said denormal detection on said first floating-point operand, said second floating-point operand and said third floating-point operand to determine if an expected FMA output based on said first floating-point operand, said second floating-point operand and said third floating-point operand meets a second denormal condition.

4. The data processing apparatus of claim 3, wherein said FMA circuitry is configured to:
upon determining that said expected FMA output meets said second denormal condition, execute said denormal handling instruction; or
upon determining that said expected FMA output does not meet said second denormal condition, omit said denormal handling instruction and execute said FMA instruction using said first floating-point operand, said second floating-point operand, and said third floating-point operand to generate an FMA output.

5. The data processing apparatus of claim 1, wherein said first floating-point operand comprises a first biased exponent, said second floating-point operand comprises a second biased exponent, and said third floating-point operand comprises a third biased exponent, and said first denormal condition is met when said first biased exponent, said second biased exponent or said third biased exponent is 0.

6. The data processing apparatus of claim 3, wherein said first floating-point operand comprises a first exponent (ea), said second floating-point operand comprises a second exponent (eb), and said third floating-point operand comprises a third exponent (ec), and wherein whether said expected FMA output meets said second denormal condition is determined by:
a first inequality based on the sum of said first exponent and said second exponent, ea+eb, when a product of said first floating-point operand and said second floating-point operand, a*b, dominates over said third floating-point operand, c; or
a second inequality based on said third exponent, ec, when said third floating-point operand, c, dominates over said product of said first floating-point operand and said second floating-point operand, a*b; or
a third inequality based on of said first exponent and said second exponent, ea+eb, and said third exponent, ec, when said product of said first floating-point operand and said second floating-point operand, a*b, and said third floating-point operand, c, are similar in magnitude.

7. The data processing apparatus of claim 1, wherein said FMA circuitry is configured to execute said denormal handling instruction further to:
generate said shifted first floating-point operand (ta) based on said first floating-point operand by adding a first integer x to a first exponent (ea);
generate said shifted second floating-point operand (tb) based on said second floating-point operand by adding a second integer y to a second exponent (eb); and
generate said shifted third floating-point operand (tc) based on said third floating-point operand by adding a third integer z to a third exponent (ec),
wherein each of said first exponent, said second exponent or said third exponent is a respective exponent of said first floating-point operand, said second floating-point operand and said third floating-point operand, and said third integer is a sum of said first integer and said second integer, z=x+y,
wherein, optionally, an operation to generate said shifted first, second or third floating-point operand is an “Idexp” operation.

8. The data processing apparatus of claim 7, wherein said FMA circuitry is configured to execute said denormal handling instruction further to:
write said shifted FMA output to said auxiliary storage of said operand storage module; and
generate an FMA output based on said shifted FMA output.

9. The data processing apparatus of claim 8, wherein said FMA circuitry generates said FMA output based on said shifted FMA output by subtracting said third integer from an exponent of said shifted FMA output.

10. The data processing apparatus of claim 7, wherein said first integer (x) is set within a first predetermined range of numbers determined based on a precision specified for said first floating-point operand, and said second integer (y) is set within a second predetermined range of numbers determined based on a precision specified for said second floating-point operand.

11. The data processing apparatus of claim 7, wherein said first integer and said second integer are set to be a same number.

12. The data processing apparatus of claim 7, wherein said first floating-point operand and said second floating-point operand are single-precision floating-point numbers, and said first integer and said second integer are set to be 24.

13. The data processing apparatus of claim 1, wherein said FMA circuitry is configured to execute said denormal handling instruction further to:
upon generating said shifted FMA output, invalidate said shifted first floating-point operand, said shifted second floating-point operand and said shifted third floating-point operand on said auxiliary storage of said operand storage module.

14. A computer-implemented method comprising:
instruction decode circuitry decoding instructions;
processing circuitry executing said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and
an operand storage module storing said first floating-point operand, said second floating-point operand, and said third floating-point operand,
the method further comprising, responsive to said FMA instruction, said FMA circuitry:
performing denormal detection on said first floating-point operand, said second floating-point operand and said third floating-point operand to determine if one or more of said first floating-point operand, said second floating-point operand or said third floating-point operand meets a first denormal condition;
upon determining that at least one of said first floating-point operand, said second floating-point operand or said third floating-point operand meets said first denormal condition, executing a denormal handling instruction:
generating a shifted first floating-point operand (ta) based on said first floating-point operand, a shifted second floating-point operand (tb) based on said second floating-point operand, and a shifted third floating-point operand (tc) based on said third floating-point operand;
writing said shifted first floating-point operand, said shifted second floating-point operand and said shifted third floating-point operand to auxiliary storage of said operand storage module, said auxiliary storage being temporary storage configured within said operand storage module and assigned to said denormal handling instruction; and
executing said FMA instruction using said shifted first floating-point operand, said shifted second floating-point operand and said shifted third floating-point operand to generate a shifted FMA output.

15. The method of claim 14, further comprising said FMA circuitry, upon determining that none of said first floating-point operand, said second floating-point operand, and said third floating-point operand meets said first denormal condition, executing said FMA instruction using said first floating-point operand, said second floating-point operand, and said third floating-point operand to generate an FMA output.

16. The method of claim 14, further comprising said FMA circuitry performing said denormal detection on said first floating-point operand, said second floating-point operand and said third floating-point operand to determine if an expected FMA output based on said first floating-point operand, said second floating-point operand and said third floating-point operand meets a second denormal condition.

17. The method of claim 16, further comprising said FMA circuitry:
upon determining that said FMA output meets said second denormal condition, executing said denormal handling instruction; or
upon determining that said expected FMA output does not meet said second denormal condition, omit said denormal handling instruction and execute said FMA instruction using said first floating-point operand, said second floating-point operand, and said third floating-point operand to generate an FMA output.

18. The method of claim 14, wherein said FMA circuitry executes said denormal handling instruction by:
generating said shifted first floating-point operand (ta) based on said first floating-point operand by adding a first integer x to a first exponent (ea);
generating said shifted second floating-point operand (tb) based on said second floating-point operand by adding a second integer y to a second exponent (eb); and
generating said shifted third floating-point operand (tc) based on said third floating-point operand by adding a third integer z to a third exponent (ec),
wherein each of said first exponent, said second exponent or said third exponent is a respective exponent of said first floating-point operand, said second floating-point operand and said third floating-point operand, and said third integer is a sum of said first integer and said second integer, z=x+y,
wherein, optionally, generating said shifted first, second or third floating-point operand comprises performing an “Idexp” operation.

19. The method of claim 17, wherein said FMA circuitry executes said denormal handling instruction by:
writing said shifted FMA output to said auxiliary storage of said operand storage module; and
generating an FMA output based on said shifted FMA output by subtracting said third integer from an exponent of said shifted FMA output.

20. A non-transitory computer-readable medium to store computer-readable code for fabrication of a data processing apparatus comprising:
instruction decode circuitry to decode instructions;
processing circuitry to execute said instructions decoded by said instruction decode circuitry, said processing circuitry comprising fused-multiply-accumulate, FMA, circuitry to respond to a fused-multiply-accumulate, FMA, instruction decoded by said instruction decoder, said FMA instruction specifying a first floating-point operand (a), a second floating-point operand (b) and a third floating-point operand (c); and
an operand storage module operable to store said first floating-point operand, said second floating-point operand, and said third floating-point operand,
wherein, responsive to said FMA instruction, said FMA circuitry is configured to:
perform denormal detection on said first floating-point operand, said second floating-point operand and said third floating-point operand to determine if one or more of said first floating-point operand, said second floating-point operand or said third floating-point operand meets a first denormal condition;
upon determining that at least one of said first floating-point operand, said second floating-point operand or said third floating-point operand meets said first denormal condition, execute a denormal handling instruction to:
generate a shifted first floating-point operand (ta) based on said first floating-point operand, a shifted second floating-point operand (tb) based on said second floating-point operand, and a shifted third floating-point operand (tc) based on said third floating-point operand;
write said shifted first floating-point operand, said normalized second floating-point operand and said shifted third floating-point operand to auxiliary storage of said operand storage module, said auxiliary storage being temporary storage configured within said operand storage module and assigned to said denormal handling instruction; and
execute said FMA instruction using said shifted first floating-point operand, said shifted second floating-point operand and said shifted third floating-point operand to generate a shifted FMA output.
